(19) United States
(12) Patent Application Publication
(10) Pub. No.: US 2008/0061198 A1
(43) Pub. Date: Mar. 13, 2008

(54) Carrier and Adaptor for Transporting a Bicycle on a Fork Mount Holding/Transporting System

(75) Inventor: Bobby Noyes, Boulder, CO (US)

Correspondence Address: THE OLLILA LAW GROUP LLC, 2060 BROADWAY, SUITE 300, BOULDER, CO, 80302, US

(73) Assignee: ROCKY MOUNTS, Boulder, CO (US)

(21) Appl. No.: 11/850,339

(22) Filed: Sep. 5, 2007

Related U.S. Application Data
(60) Provisional application No. 60/843,463, filed on Sep. 8, 2006.

(51) Int. Cl. B21D 53/40; B60R 9/10

(52) U.S. Cl. 248/205.1; 29/11

(57) ABSTRACT

A bicycle carrier includes a base and a clam shell for retaining an axle. The clam shell includes a bottom, which is coupled to the base and a lid. The lid is hingedly coupled to the clam shell and is capable of rotating between an open and closed position. A lever is coupled to the bottom and adapted to secure the lid in the closed position.

### FIELD OF INVENTION

This invention relates to an adapter device for attachment to the end of the fork of a bicycle to facilitate attachment of the bicycle to a bike rack after removal of the front wheel.

### BACKGROUND OF THE INVENTION

The typical bicycle has a fork which is adapted to receive an axle of a front wheel assembly. The axle of the front wheel assembly is received in the ends of the fork and engaged on the front fork ends using various means including clamps, quick releases, or nuts.

The fork is commonly used as a means for attaching the bike on bike racks or carriers usually positioned on the roof of an automobile or in the bed of a truck. The carrier is adapted to hold the bike in an upright vertical position. The wheel of the bike is removed and the fork is inserted onto the carrier. The carrier may have a transverse rod which mimics the axle of the wheel assembly. The fork is positioned on the rod in much the same way as the front wheel axle fits in the ends of the fork. Alternatively, the carrier may have extensions on either end that fork clamps attach to.

In addition to the carriers, adapters are provided that allow for multiple fork designs to be mounted on a carrier. These adapters are mounted on the carrier and the bike fork is attached to the adapter. An example of such an adapter is U.S. Pat. No. 6,036,069.

The problems with the solutions above are that the assembly of the fork to the carrier or adapter is cumbersome and time consuming.

The present invention describes a carrier and adapter for bike forks that allow for various fork designs to be mounted on the same bike rack or carrier.

### SUMMARY OF INVENTION

Briefly, the invention relates to a carrier and adapter device for attachment to a bicycle fork axle or dummy axle/rod.

More particularly, the invention is directed to a bike carrier device for transporting a bicycle. The carrier is of a clam shell type design with a lever locking means.

The invention further includes an adapter device for use with other carriers. The adapter has an innovative attachment feature that allows for the adapter to fit onto carriers using a closed end and open end combination.

A bicycle carrier is provided according to an embodiment of the invention. The bicycle carrier comprises a base and a clam shell for retaining an axle. The clam shell includes a bottom coupled to the base and a lid hingedly coupled to the bottom. The lid is capable of rotating between an open and closed position. The bicycle carrier further comprises a lever coupled to the clam shell and adapted to secure the lid in the closed position.

A bicycle carrier adapter is provided according to an embodiment of the invention. The bicycle carrier adapter comprises a clam shell for retaining an axle. The clam shell includes a bottom and a lid hingedly coupled to the bottom. The bicycle carrier adapter further comprises a lever coupled to the clam shell and adapted to secure the lid closed. The bicycle carrier adapter further comprises two or more legs coupled to the clam shell. The two or more legs are adapted to engage a carrier.

A method for forming a bicycle axle mount is provided according to an embodiment of the invention. The method comprises coupling a clam shell to two or more legs. The clam shell is adapted to retain an axle and includes a bottom and a lid hingedly coupled to the bottom. The method further comprises positioning a lever on the clam shell such that the lever can rotate to secure the lid closed.

### BRIEF DESCRIPTION OF THE DRAWINGS

FIG. 1 shows a prior art standard carrier.

FIG. 2 shows an exploded perspective view of a carrier.

FIG. 3 shows a perspective view of a clam shell lid.

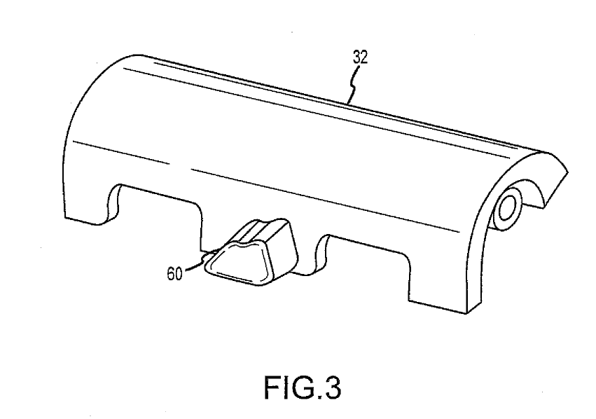

FIG. 4 shows a front elevation of a lever.

FIG. 5 shows is a back elevation of the lever.

FIG. 6 shows an exploded perspective view of an adapter.

FIG. 7 shows a back elevation of a base.

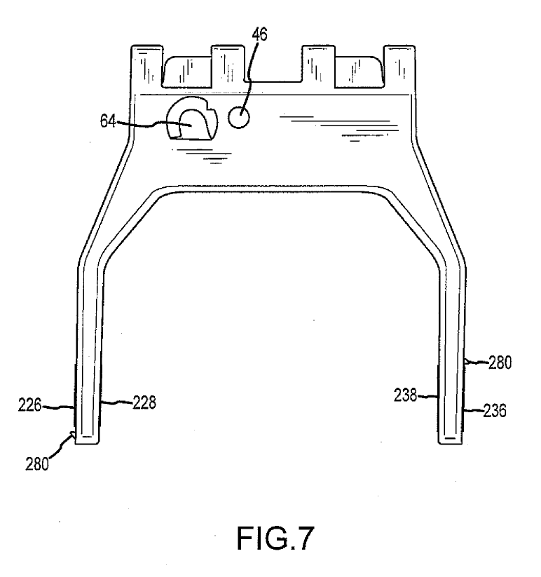

FIG. 8 shows a standard lock.

### ITEM LIST

| | | | |
|---|---|---|---|
| 1 | Standard Carrier | 2 | Mount |
| 3 | Rod | 4 | Legs |
| 10 | Clam shell carrier | 20 | Base |
| 22 | Platform | 24 | mounting holes |
| 28 | Legs | 30 | Clam shell |
| 32 | Clam shell lid | 34 | Clam shell bottom |
| 36 | hinges | 38 | hinge pins |
| 40 | lever | 42 | pivot bolt |
| 44 | lever hole | 46 | Bolt/Pivot hole |
| 48 | nut | 50 | Keyway |
| 52 | catch | 54 | lever stop (closed |
| | | | position) |
| 56 | lever stop (open/closed position) | 58 | protrusion |
| 60 | detent | 62 | lock core |
| 64 | Lock channel | 70 | axle (real or dummy) |
| 74 | Registration groove/slot (c-clip) | 76 | Registration groove or |
| | | | protrusion |
| 78 | Shim cavities | 80 | lateral movement |
| | | | restrictors |
| 200 | Thru-axle adapter | 220 | Open leg |
| 222 | open end | 224 | slot |
| 226 | clamp surface | 228 | carrier surface |
| 230 | closed leg | 232 | closed end |
| 234 | through-hole | 236 | clamp surface |
| 238 | carrier surface | 240 | keyway |
| 242 | clamp hole | 250 | outer periphery |
| 260 | inner periphery | 280 | safety tab |
| 300 | lock | 301 | Key |

### DETAILED DESCRIPTION OF EMBODIMENTS

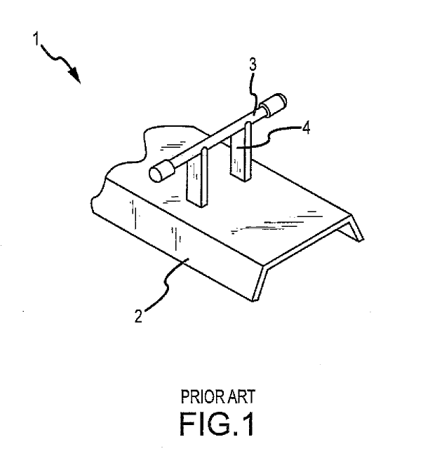

FIG. 1 shows a prior art carrier 1. The prior art carrier 1 includes a base 2 and a rod 3 attached to the base 2 by legs 4. Typically the fork of a bicycle would be positioned on the rod 3 and held using some known means. Additionally, the base 2 could be secured to a vehicle, for example, using known means.

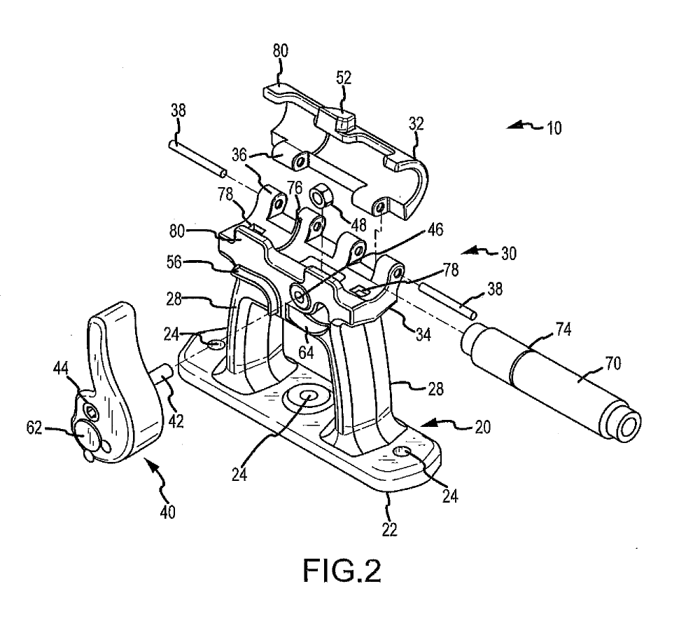

FIG. 2 shows a clam shell bike carrier 10 according to an embodiment of the invention. The carrier 10 is comprised of a base 20 and a clam shell 30. Base 20 has a platform 22 which attaches to a vehicle or other structure using mounting holes 24. Extending from platform 22 are legs 28 which support clam shell 30.

Clam shell 30 consists of lid 32 and bottom 34. Lid 32 is attached to bottom 34 via hinges 36 and pin 38. Lid 32 and bottom 34 may also consist of features that prevent the lateral movement of lid 32. For example, lid 32 and bottom 34 may comprise a series of cavities or extensions that interact to prevent such lateral movements of lid 32.

Clam shell 30 is secured closed using lever 40. Lever 40 is mounted to bottom 32 using pivot bolt 42. Pivot bolt 42 is inserted into lever hole 44 formed in lever 40 and bolt hole 46 formed in bottom 34 and secured using nut 48.

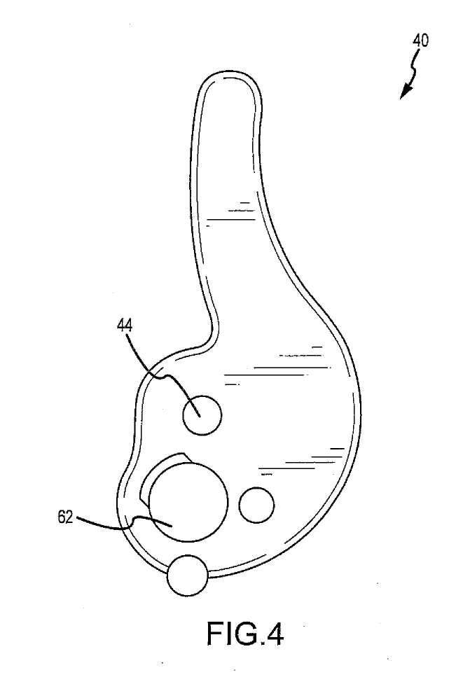

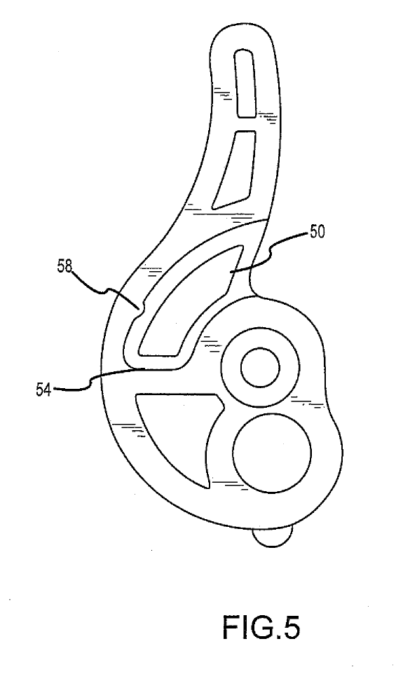

In operation, lid 32 is closed and lever 40 is rotated in a counter clock-wise direction. Keyway 50, located in lever 40 (FIG. 5), moves over catch 52 located on lid 32. In its closed position lever 40 is prevented from being over rotated by stop surface 54 contacting catch 52 and stop surface 56 contacting an outer surface of lever 40. Further, lever 40 also has a protrusion 58 which interacts with a detent 60 formed on catch 52 (See FIG. 4) to prevent unwanted unlatching of the lever 40 in certain circumstances (i.e. vibration).

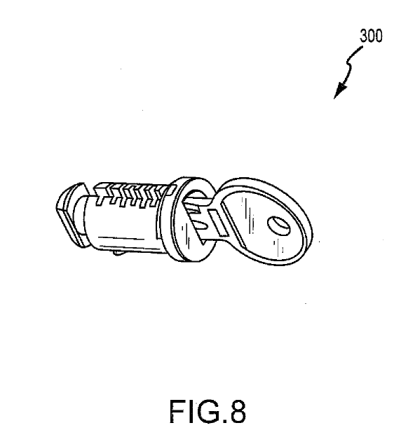

To further ensure the undesirable unlatching of the lever 40, carrier 10 may comprise a locking mechanism. An example of a locking mechanism includes a standard key actuated lock 300 (FIG. 8). The precise lock used is not important for the present invention and a variety of styles may function properly. The lock 300 can be inserted into lock core 62 formed in lever 40 and extends into lock channel 64 formed in bottom 34. Lock channel 64 contains a catch feature in the form of a cavity, undercut or the like which interacts with the lock 300, preventing movement of lever 40.

To mount the bike to the carrier 10, the front wheel of the bike is removed. The axle of the bike or a dummy axle 70 (depending on bike style) attached to the bike, is placed into clam shell 30. A locating feature may be provided in axle 70 and shell 30 to ensure proper location of axle 70 in shell 30. An example locating feature may comprise a registration groove/slot or protrusion 74 located on axle 70 that interacts with a corresponding protrusion or groove/slot 76 located in the shell 30. As an alternative, both axle 70 and shell 30 may have grooves in which a c-clip may be inserted.

Once axle 70 is located in shell 30, the lid 32 is closed and lever 40 is actuated into a closed position. In some cases it may be desirable to prevent marking of the axle during insertion or removal or it may be necessary to accommodate varying sizes of axles. In order to accomplish these goals, shim cavities 78 are located in shell 30. Cavities 78 allows for the placement of inserts (rubber, plastic or the like) that will cushion axle 70 as well as restrain any lateral movement of axle 70. While the shim cavities 78 are shown in bottom 34, it should be understood that the shim cavities 78 could be located anywhere within shell 30.

In addition to carrier 10, an adapter 200 is disclosed that allows for the use of current carriers.

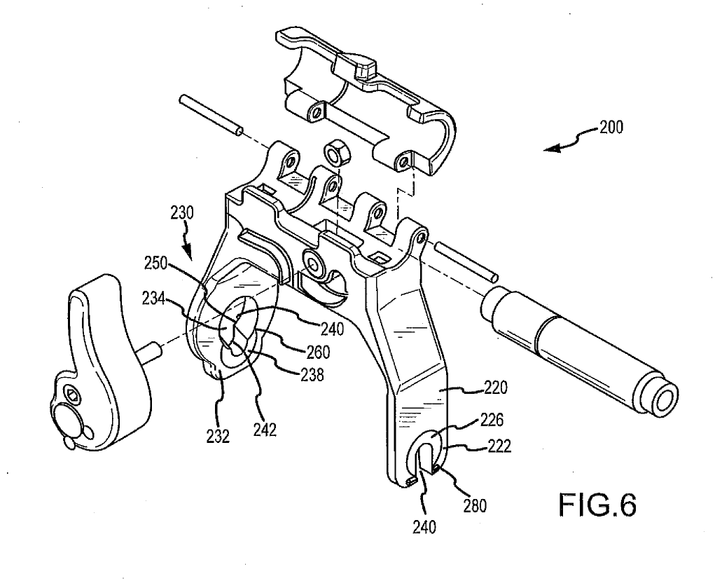

FIG. 6 shows the adapter 200 according to an embodiment of the invention. Adapter 200 may be comprised of similar elements as described above with the exception of platform 22. Instead of platform 22, adapter 200 is attached to a carrier using legs 220 and 230. For example, adapter 200 may be attached to a carrier similar to the prior art carrier 1 shown in FIG. 1. Leg 220 ends in an open end 222. Open end 222 consists of slot 224 and an outer clamp surface 226 and an inner block surface 228.

Leg 230 consists of a closed end 232 having a through-hole 234, an outer clamp surface 236, and an inner block surface 238. Through-hole 234 is comprised of a keyway 240 and a clamp hole 242. In alternative embodiments, leg 230 may be substantially similar to leg 220.

In operation, adapter 200 is inserted over a carrier and clamped to the carrier. The carrier will usually have two cylindrical protrusions that interact with slot 224 and through-hole 234. A first cylindrical protrusion of a carrier is slid into through-hole 224 via keyway 240. Once inside keyway 240, the cylindrical protrusion is slid into clamp hole 242. Slot 224 of adapter 200 is then placed on the second cylindrical protrusion of the carrier. A clamping mechanism (i.e. bolt/nut, quick-clamp etc.) is inserted into the carrier and adapter through legs 220 and 230. The clamp compresses against clamp surfaces 226 and 236 which in turn forces carrier surfaces 228 and 238 against the carrier. Safety tabs 280 may be provided on leg 220 to prevent the adapter from releasing from the clamp in cases when the clamp becomes loose.

In order to allow for easier insertion, the outer periphery 250 and the inner periphery 260 of through-hole 234 may be offset. This offset causes a taper in the interior surface of the through-hole, which creates a guide for the carrier to pass through. It should be understood that the opening 240 in leg 220 can also include a taper in order to create a guide for the carrier.

After both legs 220, 230 are properly in place, a clamp may be used to retain the adapter on the carrier. Once in place, the adapter 200 functions substantially the same as carrier 10. However, the adapter 200 allows the ease of use provided by carrier 10 to be implemented with prior art standard carriers.

The above described invention provides a device which can be used to quickly and easily attach a bicycle to a vehicle for example. The invention can also be implemented to keep a bicycle in a stationary position, such as a workbench or the like by using the mounting platform. Unlike prior art carriers which typically engage the forks of a bicycle, the present invention retains a bicycle by either its axle or by a dummy axle. Many times, this can be a more efficient means of holding onto the bicycle. Additionally, the clam shell design provides for a quick release of the bicycle.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention.

Thus, although specific embodiments oft and examples for, the invention are described herein for illustrative purposes, various equivalent modifications are possible within the scope of the invention, as those skilled in the relevant art will recognize. The teachings provided herein can be applied to other carriers, and not just to the embodiments described above and shown in the accompanying figures. Accordingly, the scope of the invention should be determined from the following claims.

We claim:

1. A bicycle carrier comprising:
a base;
a clam shell for retaining an axle and including:
a bottom coupled to the base;
a lid hingedly coupled to the bottom and rotatable between an open and closed position; and
a lever coupled to the clam shell and adapted to secure the lid in the closed position.

2. The bicycle carrier of claim 1, wherein the clam shell further comprises a catch adapted to engage the lever.

3. The bicycle carrier of claim 1, further comprising a locking mechanism.

4. The bicycle carrier of claim 3, wherein the locking mechanism comprises a lock core in the lever and a lock channel in the bottom, the lock core and lock channel aligned to accept a lock.

5. The bicycle carrier of claim 1, wherein the clam shell further comprises a locating feature.

6. The bicycle carrier of claim 5, wherein the locating feature comprises a registration groove on one of the axle or clam shell and a corresponding protrusion on one of the clam shell or the axle opposite the registration groove.

7. A bicycle carrier adapter comprising:
a clam shell for retaining an axle and including:
a bottom; and
a lid hingedly coupled to the bottom and rotatable between an open and closed position;
a lever coupled to the clam shell and adapted to secure the lid closed; and
two or more legs coupled to the clam shell adapted to engage a carrier.

8. The bicycle carrier adapter of claim 7, wherein one of the two or more legs comprises a closed end including:
a keyway; and
a clamp hole.

9. The bicycle carrier adapter of claim 7, wherein one of the two or more legs comprises an open end including a slot.

10. The bicycle carrier adapter of claim 9, further comprising safety tabs located on the open end.

11. The bicycle carrier adapter of claim 7, wherein the clam shell further comprises a catch adapted to engage the lever.

12. The bicycle carrier of claim 7, further comprising a locking mechanism.

13. The bicycle carrier of claim 12, wherein the locking mechanism comprises a lock core located in the lever and a lock channel located in the bottom, the lock core and lock channel aligned to accept a lock.

14. The bicycle carrier of claim 7, wherein the clam shell further comprises a locating feature.

15. The bicycle carrier of claim 14, wherein the locating feature comprises a registration groove on one of the axle or clam shell and a corresponding protrusion on one of the clam shell or the axle opposite the registration groove.

16. A method for forming a bicycle axle mount, comprising:
coupling a clam shell to two or more legs, the clam shell adapted to retain an axle and including:
a bottom;
a lid hingedly coupled to the bottom; and
positioning a lever on the clam shell such that the lever can rotate to secure the lid closed.

17. The method of claim 16, further comprising coupling the two or more legs to a platform.

18. The method of claim 16, further comprising forming a through-hole in one of the two or more legs, the through-hole capable of accepting a first protrusion of a carrier and forming a slot in one of the two or more legs, the slot capable of accepting a second protrusion of a carrier.

19. The method of claim 16, further comprising forming a catch on the lid to engage the lever.

20. The method of claim 16, further comprising forming lock core in the lever and a lock channel in the bottom, such that a lock can be inserted into the lock core and lock channel to prevent movement of the lever.

21. The method of claim 16, further comprising forming a groove in one of the clam shell or the axle and forming a corresponding protrusion on one of the axle or the clam shell.
